(19) United States
(12) Patent Application Publication
(10) Pub. No.: US 2008/0271289 A1
(43) Pub. Date: Nov. 6, 2008

(54) Hinge assembly

(76) Inventors: Jia-Hao Hsu, Shulin City (TW); Ting-Hsien Wang, Shulin City (TW)

Correspondence Address: Hershkovitz & Associates, LLC, 2845 Duke Street, Alexandria, VA, 22314, US

(21) Appl. No.: 11/797,516

(22) Filed: May 4, 2007

(51) Int. Cl. E05D 7/06

(52) U.S. Cl. 16/234

(57) ABSTRACT

A hinge assembly attaches a cover pivotally to a base of an electronic device such as a notebook computer and has a base bracket, a pintle and a cover bracket. The base bracket is attached to the base and has a gudgeon. The pintle is mounted securely in the gudgeon in the base bracket. The cover bracket is mounted tightly and rotatably around the pintle and securely on the cover of the electronic device, allows the cover to pivot on the base and has a through ring and a pivoting gudgeon. The through ring is mounted tightly around the pintle and has an open slot to prevent the through ring and the pintle from wearing. The pivoting gudgeon is slightly narrower than the through ring, fastens the pintle to position the cover and has an open slot to prevent the pivoting gudgeon and the pintle from wearing.

### BACKGROUND OF THE INVENTION

1. Field of the Invention

The present invention relates to a hinge assembly, and more particularly to a hinge assembly to attach a cover pivotally to a base of an electronic device.

2. Description of the Prior Arts

Many modern electronic devices such as notebook computers, cell phones, PDAs (personal digital assistance), etc. have a cover, a base and a conventional hinge. The conventional hinge connects the cover pivotally to the base and provides friction to hold the cover in one or more desired positions relative to the base to make the modern electronic devices more convenient for a person to operate.

With reference to FIG. 4, one of the conventional hinges comprises a cover bracket (60) and a base bracket (50).

The cover bracket (60) has a distal end, a proximal end, a shaft (61) and a leaf (62). The shaft (60) is protruded from the distal end of the cover bracket (60). The leaf (62) is protrudes from the proximal end of the cover bracket (60).

The base bracket (50) is mounted tightly and rotatably around the distal end of the cover bracket (60) and has a proximal end, a distal end, a pivoting gudgeon (51), an open slot (52) and a leaf (53). The pivoting gudgeon (51) is formed in the proximal end of the base bracket (50), is slightly narrower than the shaft (61) of the cover bracket (60), is mounted tightly and rotatably around the shaft (61) and has a sidewall and two ends. The open slot (52) is formed longitudinally through the sidewall of the pivoting gudgeon (51), communicates with the two ends of the pivoting gudgeon (51) and allows the pivoting gudgeon (51) to mount around the shaft (61) when being pressed to enlarge. The leaf (53) is formed on the distal end of the base bracket (50).

Even though the conventional hinge is tightly made to hold the cover in desired positions relative to the base, the conventional hinge often wears after the electronic devices are used time after time still, and is not able to hold the cover in the desired position.

To overcome the shortcomings, the present invention provides a hinge assembly to mitigate or obviate the aforementioned problems.

### SUMMARY OF THE INVENTION

The primary objective of the present invention is to provide a hinge assembly that prevents the hinge from wearing when used frequently.

A hinge assembly attaches a cover pivotally to a base of an electronic device such as a notebook computer and has a base bracket, a pintle and a cover bracket. The base bracket is mounted on the base and has a gudgeon. The pintle is mounted securely in the gudgeon in the base bracket. The cover bracket is mounted tightly and rotatably around the pintle and securely on the cover of the electronic device, allows the cover to pivot on the base and has a through ring and a pivoting gudgeon. The through ring is mounted tightly around the pintle and has an open slot to prevent the through ring and the pintle from wearing. The pivoting gudgeon is slightly narrower than the through ring, fastens the pintle to position the cover and has an open slot to prevent the pivoting gudgeon and the pintle from wearing.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge assembly in accordance with the present invention;

FIG. 2 is a perspective view of the hinge assembly in FIG. 1;

FIG. 3 is an operational perspective view of the hinge assembly in FIG. 1 mounted on a notebook computer; and

FIG. 4 is an exploded perspective view of a conventional hinge in accordance with the prior art.

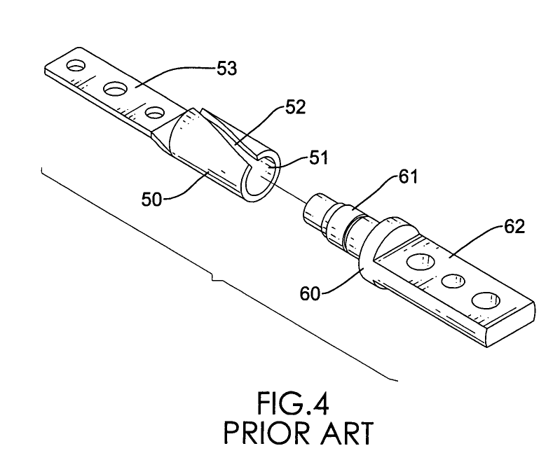

### DETAILED DESCRIPTION OF THE PREFERRED EMBODIMENTS

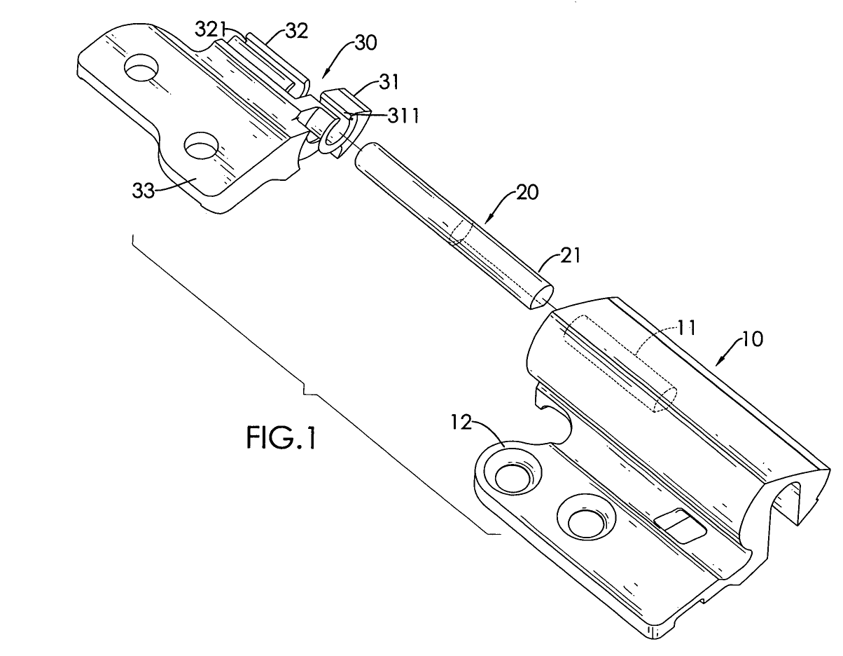

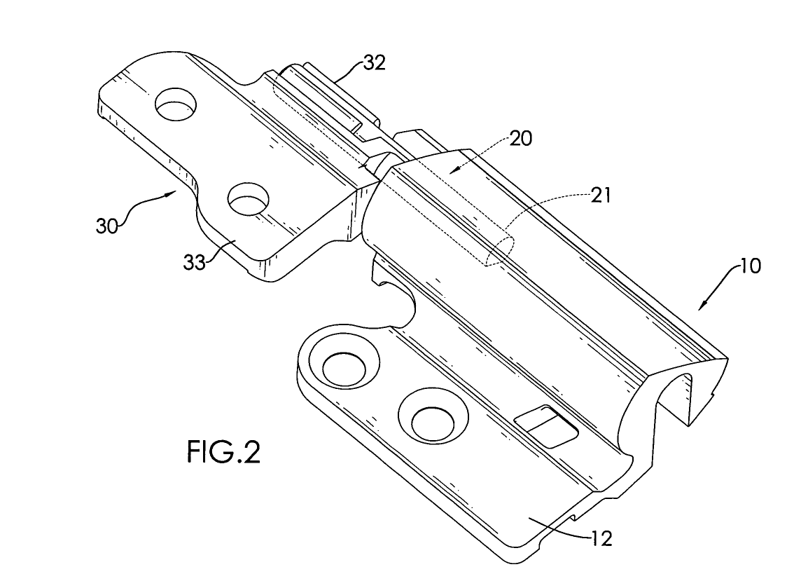

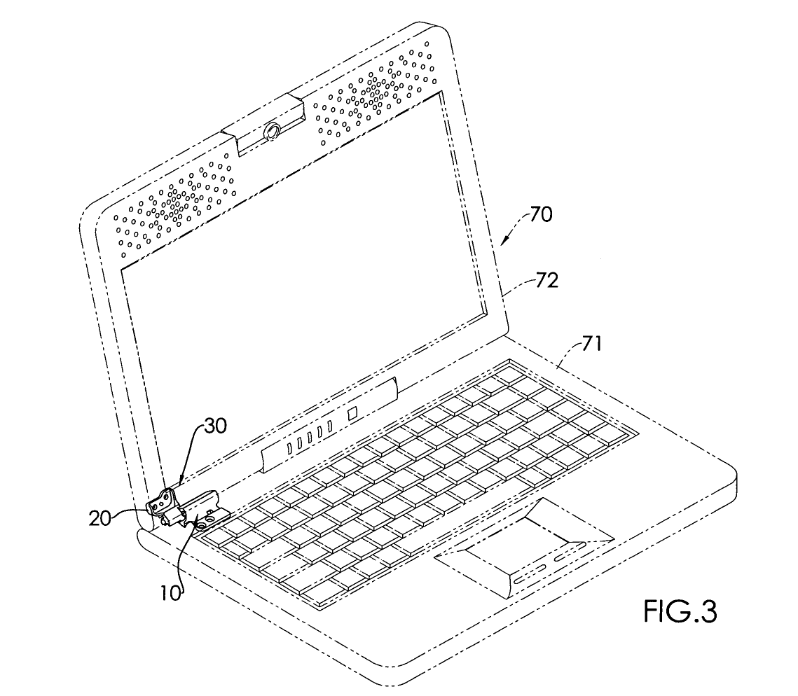

With reference to FIGS. 1 to 3, a hinge assembly in accordance with the present invention attaches a cover (72) pivotally to a base (71) of an electronic device (70) such as a notebook computer and comprises a base bracket (10), a pintle (20) and a cover bracket (30).

The base bracket (10) is attached securely to the base (71) of the electronic device (70) and has a side surface, a distal end, an optional leaf (12) and a gudgeon (11).

The leaf (12) of the base bracket (10) is formed longitudinally on and protrudes transversely from the side surface of the base bracket (10) and is attached securely to the base (71) of the electronic device (70).

The gudgeon (11) is formed coaxially in the distal end of the base bracket (10) and may be keyed (i.e. have a non-circular in cross-section, a longitudinal groove or the like).

The pintle (20) is mounted securely in and protrudes longitudinally from the distal end of the base bracket (10) and has a proximal end, a distal end and a mounting segment (21).

The mounting segment (21) is formed on and protrudes coaxially from the proximal end of the pintle (20) and corresponds to and is mounted securely in the gudgeon (11) in the base bracket (10).

The cover bracket (30) is mounted rotatably and tightly around the pintle (20), abuts the distal end of the base bracket (10), is attached securely to the cover (72) of the electronic device (70), allows the cover (72) to pivot on the base (71) and has a proximal end, a distal end, a side surface, a through ring (31), a pivoting gudgeon (32) and an optional leaf (33).

The through ring (31) is formed on the proximal end of the cover bracket (30), corresponds to and, is mounted tightly and rotatably around the pintle (20), abuts the distal end of the base bracket (10), keeps the cover bracket (30) rotating smoothly and stably relative to the pintle (20) and has a sidewall, two ends and an open slot (311). The open slot (311) is formed longitudinally through the sidewall of the through ring (31), communicates with the two ends of the through ring (31) and prevents the through ring (31) and the pintle (20) from wearing when the cover bracket (30) rotates frequently around the pintle (20).

The pivoting gudgeon (32) is slightly narrower than the through ring (31), is formed in the distal end of the cover bracket (30), is mounted tightly and rotatably around the distal end of the pintle (20), fastens the pintle (20) to provide friction to position the cover (72) and has a sidewall, two ends and an open slot (321). The open slot (321) is formed longitudinally through the sidewall of the pivoting gudgeon (32), communicates with the two ends of the pivoting gudgeon (31) and prevents the pivoting gudgeon (32) and pintle (20) from wearing when the cover bracket (30) rotates frequently around the pintle (20).

The leaf (33) of the cover bracket (30) is formed longitudinally on and protrudes transversely from the side surface of the cover bracket (30) and is attached securely to the cover (72) of the electronic device (70).

Consequently, the hinge assembly not only provides friction to hold the cover in one or more desired positions relative to the base but also prevents the pivoting gudgeon (32) and the pintle (20) from wearing after being used frequently.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly comprising
a base bracket having
a side surface;
a distal end; and
a gudgeon being formed coaxially in the distal end of the base bracket;
a pintle being mounted securely in and protruding longitudinally from the distal end of the base bracket and having
a proximal end;
a distal end; and
a mounting segment being formed on and protruding coaxially from the proximal end of the pintle and corresponding to and being mounted securely in the gudgeon in the base bracket; and
a cover bracket being mounted rotatably and tightly around the pintle, abutting the distal end of the base bracket and having
a proximal end;
a distal end;
a side surface;
a through ring being formed on the proximal end of the cover bracket, corresponding to and being mounted tightly and rotatably around the pintle, abutting the distal end of the base bracket and having
a sidewall;
two ends; and
an open slot being formed longitudinally through the sidewall of the through ring and communicating with the two ends of the through ring; and
a pivoting gudgeon being slightly narrower than the through ring, being formed in the distal end of the cover bracket, being mounted tightly and rotatably around the distal end of the pintle, fastening the pintle and having
a sidewall;
two ends; and
an open slot being formed longitudinally through the sidewall of the pivoting gudgeon and communicating with the two ends of the pivoting gudgeon.

2. The hinge assembly as claimed in claim 1, wherein the base bracket further has a leaf being formed on and protruding transversely from the side surface of the base bracket.

3. The hinge assembly as claimed in claim 1, wherein the cover bracket further has a leaf being formed longitudinally on and protruding transversely from the side surface of the cover bracket.

4. The hinge assembly as claimed in claim 1, wherein the gudgeon in the base bracket is keyed.
